(19) United States
(12) Patent Application Publication
(10) Pub. No.: US 2024/0346830 A1
(43) Pub. Date: Oct. 17, 2024

(54) DYNAMIC INDIVIDUALIZED HAZARD DETECTION USING MOBILE ROBOTICS

(71) Applicant: INTERNATIONAL BUSINESS MACHINES CORPORATION, ARMONK, NY (US)

(72) Inventors: ZACHARY A. SILVERSTEIN, AUSTIN, TX (US); JACOB RYAN JEPPERSON, ROCHESTER, MN (US); MELANIE DAUBER, NEW YORK, NY (US); JEREMY R. FOX, AUSTIN, TX (US); LOGAN BAILEY, SANDY SPRINGS, GA (US)

(21) Appl. No.: 18/300,780

(22) Filed: Apr. 14, 2023

(51) Int. Cl. G06V 20/56; A47L 9/00; A47L 9/28; G05D 1/00; G06V 10/70; G06V 20/17

(52) U.S. Cl. CPC G06V 20/56; A47L 9/009; A47L 9/2826; A47L 9/2852; A47L 9/2894; G06V 10/70; G06V 20/17; A47L 2201/04; B64U 10/14; B64U 2201/10

(57) ABSTRACT

A hazard identification system includes: a computer device comprising a hazard identification application; and a mobile robotic device for self-propelled movement within a designated environment and with an interface for communicating with the hazard identification application, the mobile robotic device further comprising a camera for imaging the designated environment. The hazard identification application is to receive imaging of the designated environment from the camera of the mobile robotic device and to identify hazards in the designated environment from the imaging.

### BACKGROUND

As a young child develops, he or she eventually gains the ability to move around, first by crawling usually and then by standing and walking. As the child is able to move around a room or living space, a parent or guardian needs to ensure that the child will not encounter any potential hazards or danger in the space. This is commonly referred to as “childproofing” the space.

To childproof a living space, the adult will need to identify anything in the space that could potentially harm the child and anticipate how that harm might occur. This can include covering electrical outlets, removing or covering sharp edges, locking or blocking cabinets or drawers that might contain dangerous objects or materials and many other such precautions. The safety factor achieved will depend on how well the adults has anticipated potential hazards from the perspective of the child.

Other scenarios also exist when someone wants to protect a vulnerable individual by safety-proofing a space. These could include vary from a care center to an employee work area.

### SUMMARY

According to an example of the present subject matter, a hazard identification system includes: a computer device comprising a hazard identification application; and a mobile robotic device for self-propelled movement within a designated environment and with an interface for communicating with the hazard identification application, the mobile robotic device further comprising a camera for imaging the designated environment. The hazard identification application is to receive imaging of the designated environment from the camera of the mobile robotic device and to identify hazards in the designated environment from the imaging.

In another example, a method of hazard identification in a designated environment includes: receiving imaging from a camera of a mobile robotic device for self-propelled movement within the designated environment; directing operation of the mobile robotic device in the designated environment based on a profile of an individual to be protected from hazards within the designated environment; and identifying hazards to the protected individual in the designated environment based on the imaging of the designated environment from the camera of the mobile robotic device.

In still another example, a computer program product comprising a non-transitory computer-readable medium storing instructions that, when executed by a processor, implement a hazard identification application, the application to: receive imaging from a camera of a mobile robotic device for self-propelled movement within the designated environment; direct operation of the mobile robotic device in the designated environment based on a profile of an individual to be protected from hazards within the designated environment; and identify hazards to the protected individual in the designated environment based on the imaging of the designated environment from the camera of the mobile robotic device.

### BRIEF DESCRIPTION OF THE DRAWINGS

FIG. 1 depicts a computing environment for the execution of a computer-implemented method or application, according to an example of the principles described herein.

FIGS. 2A and 2B illustrate examples of a hazard identification system according to principles described herein.

FIGS. 3A and 3B are flow charts illustrating examples of methods for hazard identification according to principles described herein.

FIG. 4 is another illustration of an example hazard identification system and method according to the present description.

FIG. 5 depicts a computer-readable storage medium as an example for implementing the hazard identification application described herein.

### DETAILED DESCRIPTION

As noted above, as a young child develops, he or she eventually gains the ability to move about within a living space. As the child is able to move around, a parent or guardian needs to ensure that the child will not encounter any potential hazards or danger. To childproof a living space, the adult will need to identify anything in the space that could potentially harm the child and anticipate how that harm might occur. This can include covering electrical outlets, removing or covering sharp edges, locking or blocking cabinets or drawers that might contain dangerous objects or materials and many other such precautions.

To best anticipate potential dangers to the child, the parent or guardian seeking to childproof the space will need to anticipate what the child can encounter in the space. Many things will be well out of the reach of the child and not of concern. Other potential dangers that are within the reach of the child, or soon will be, may be apparent to an adult. However, some potential dangers, particularly those lower to the ground, may not be readily apparent to an adult who is looking down from a much different perspective than the young child will have. Some things may only appear attractive or dangerous to a young child when viewed from the child's perspective. For example, some objects may appear shiny or surfaces grabbable from the child's perspective without appearing so from above.

Thus, the adult will have to try to consider the space from the perspective of the young child in order to best anticipate dangers that need to be mitigated. However, it may be difficult for the adult to effectively project herself or himself into the experience of the small child to be protected. This may also apply to someone who is trying to protect some other vulnerable person, such as a person in a wheelchair. Consequently, the present specification describes solutions for helping someone who is childproofing or safety-proofing a space to properly contextualize risks within the space based on the size or profile of the child or specific individual to be protected using mobile technology. By utilizing mobile robotic technology, this application will be able to identify relevant interaction points of concern and highlight risks that may not be visible or apparent to a user due to differences in height or perspective.

This helps to ensure the safety of families with young children and others. Specifically, the technology described herein could also be used to enhance the safety of an elderly individual or a person confined to a wheelchair, either of whom may have a different height and perspective from the person who is trying to enhance safety in a relevant space, such as a residence or care center. Similarly, the technology could be used in other contexts, such as a construction site or business, where people of different heights and perspectives may have different risk factors given their respective profiles. By identifying potential risks in the home or other environments and providing recommendations for addressing them, the application being described can help to prevent accidents and injuries. By using mobile robotic devices and machine learning algorithms to assess a specified environment, this application can also significantly reduce the amount of time and effort required to identify potential risks.

Consequently, systems and methods will be described for ingesting a profile of an individual or individual type to be protected within a specified space. The systems and method then utilize mobile technology, such as a mobile robotic device with a camera, to identify relevant interaction points and potential dangers in the specified space for the individual or individual type that has been profiled. Thus, these systems and methods provide for “person-proofing” a home, business, care center or other location using technology to identify risks specific to the size of the person or individual type profiled. By utilizing machine learning algorithms, artificial intelligence, and robotics, the described systems and methods are able to provide a comprehensive and context-specific assessment of the specified environment to ensure safety for young children or other individuals or individual types.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse or any given order, as a single integrated step, concurrently, or in a manner at least partially overlapping in time. As used in the present specification and in the appended claims, the term “a number of” or similar language is meant to be understood broadly as any positive number including 1 to infinity.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

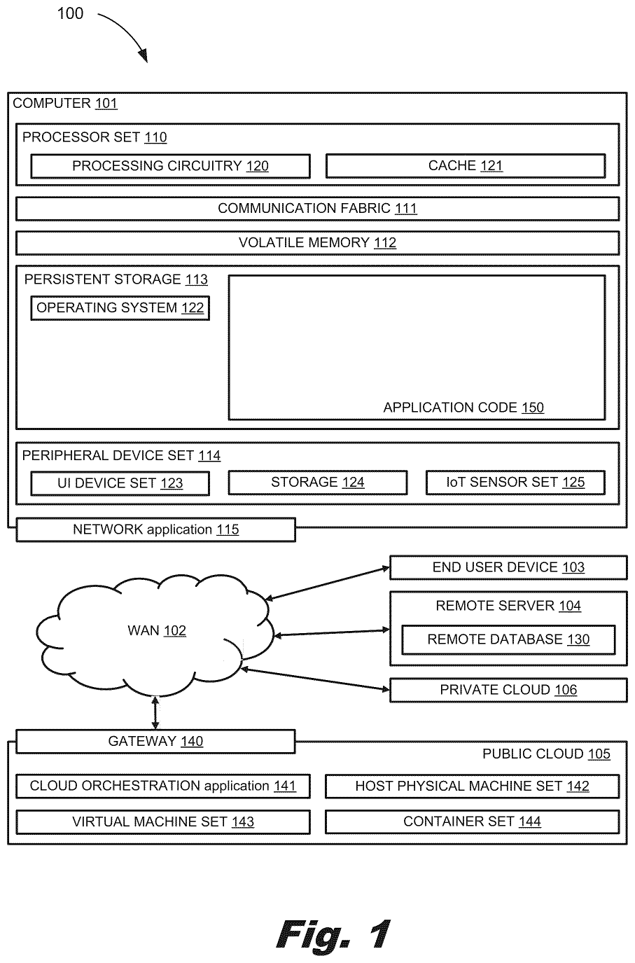

Turning now to the figures, FIG. 1 depicts a computing environment 100 for the execution of dynamic individualized risk detection based on mobile robotics, according to an example of the principles described herein. Computing environment 100 contains an example of an environment for the execution of at least some of the computer code involved in performing the inventive methods, an application to provide context specific recommendations to producers regarding the satisfaction of their users. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile robotic device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

The EUD 103 may be a client device operated by a producer of services or products that wants an analysis of available user data to ascertain user satisfaction. Operation of the EUD 103 for this objective will be described in further detail below.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

As described further below, the EUD 103 may use the network 102 to access an application on remote server 104. The application will access, again using the network 102, available user data. The application will then analyze the user data, with context specific analysis, to ascertain user satisfaction and generate recommendations for the producer based on the analysis.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

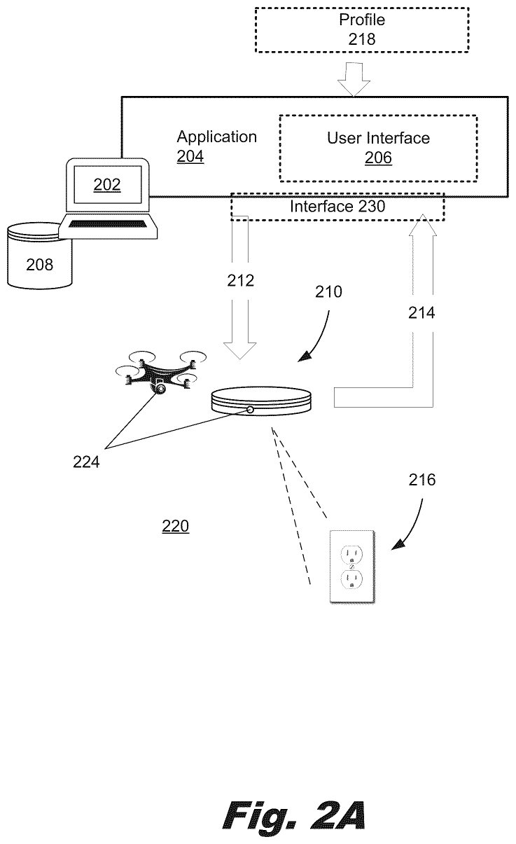

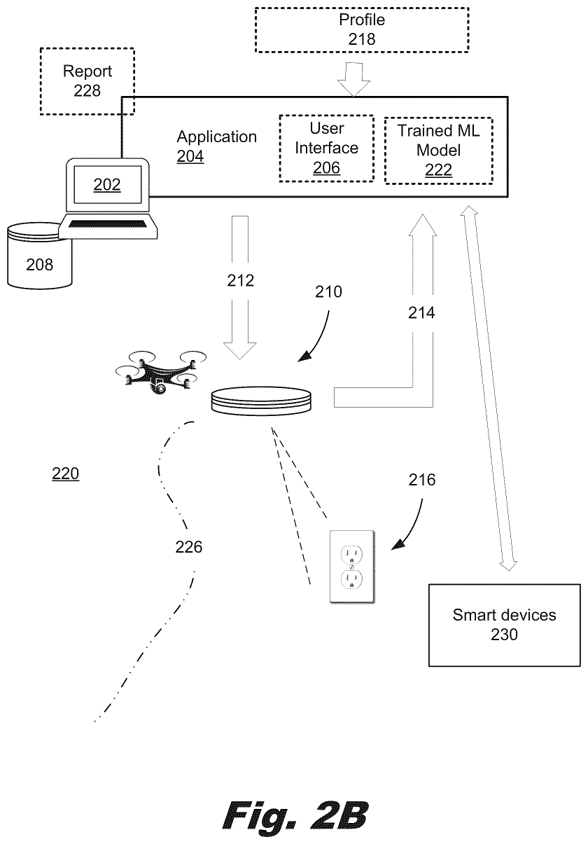

FIG. 2A illustrates an example of a hazard identification system according to principles described herein. In general, the system uses mobile robotic devices and machine learning algorithms to identify potential hazards in an environment, such as a living space, based on the profile of a child or other individual to be protected. The mobile robotic devices, such as flying drones or self-propelled vacuum cleaners, navigate through the environment and collect data on potential risks. Any mobile robotic device that can carry a camera and report imaging of the designated space may be used. An application will analyze the data collected by the mobile robotic devices and identify potential risks in the environment. The application will also provide recommendations for how to address the identified hazards. The user can also provide guidance or input to the mobile robotic devices during their normal interaction period in order to gather more information about potential risks or assess specific areas of the environment.

As shown in FIG. 2A, the system includes a hazard identification application 204, which is installed and executed on a computer device 202, such as an EUD defined above. The computer device 202 may be any computerized device with processing resources such as a smartphone, mobile phone, laptop computer, tablet computer, desktop computer, etc. Referring back to FIG. 1, the computer 101 of FIG. 1 is an example of a user device 202 that implements the application 204. The computer device 202 will have processing and memory resources 208. The application 204 is stored on the memory resources 208 of the device 202 and executed when launched.

The application 204 includes a user interface 206 to allow the user to configure the application 204, input data and instructions and receive a hazard warning report. For example, the user can input a profile 218 that defines the individual or individual type for whom hazard assessment in a space 220 is to be conducted. In such a profile, for example, the age, height, and other details of the individual or individual type may be specified.

As noted above, the application 204 will communicate with a mobile robotic device 210. The mobile robotic device 210 should have the ability to move around the environment 220 and a camera 224 to capture images or video of the environment 220. Examples of suitable mobile robotic devices include flying or other drones and self-propelled vacuum cleaners, such as the Roomba®.

As will be described in further detail below, the mobile robotic device 210 can receive instructions 212 via an interface 230 with the application 204. The interface 230 will include and utilize a wireless transceiver of the computer device 202 and communicate with the application 204. The instructions 212 may instruct the mobile robotic device 210 how to look for hazards in the environment 220. For example, if the profile 218 specifies a particular height for the eye level of an individual to be protected, a drone may be operated at that height when surveying the environment 220. The instructions 212 may further direct the mobile robotic device 210 how or where in the environment to search for hazards such as along walls that might include an electrical outlet.

Based on the instructions 212, the mobile robotic device 210 will search and image the environment 220 looking for hazards 216. Alternatively, the system may search for hazards by reviewing imaging produced while the mobile robotic device 210 is perform some other primary function, such as vacuuming. The images or video and any other data 214 captured by the mobile robotic device 210 are transmitted back to the computer device 202 and the application 204 via the interface 230. The application 204 can process the images or video received from the mobile robotic device to identify hazards in the environment 220. The application 204 may also be programmed to classify the hazards and match identified hazards to specific remedial measures that can be taken to minimize or mitigate the risk presented by the hazard. A report with the identified hazards and suggested remedial actions can then be presented to the user via the user interface 206 of the application 204.

FIG. 2B is another example of a system that is substantially similar to that of FIG. 2A. However, as shown in FIG. 2B, the application 204 may include or have access to a trained machine learning (ML) model 222. This model has been trained on a large set of images that potentially include a hazard such as might be found in the environment 220. This training teaches the model 222 to correctly identify hazards in an environment while ignoring image elements that do not actually indicate a hazard. Using this machine learning model 222 with the images from the current environment taken by the mobile robotic device 210, the application 204 can better and more accurately identify hazards in the scanned environment.

FIG. 2B also depicts that there may be a number of smart devices 230 in the environment 220. These devices may include Internet of Things (IoT) devices, such as appliances, thermostats, security devices, smart speakers, and many others. Some of these smart devices 230 could potentially pose a hazard in the environment 220. For example, an oven or stove that is active and hot may pose a hazard that could burn a child or other individual. Accordingly, the application 204 may communicate with smart devices 230 in the environment 220. If any smart device 230 reports that it is active and may, consequently, pose a hazard, the application 204 can include this in a report of identified hazards or otherwise alert a user to the hazard posed by the smart device.

As described, the present system can be used for protecting a child or other vulnerable individual from hazards in the environment 222. The system may also be used to similarly protect a pet that moves in the environment 222. In either case, an actual path 226 or paths within the environment of the person or pet to be protected can be observed and added to the profile 218. The application 204 can then direct the mobile robotic device 210 along that path to further identify hazards.

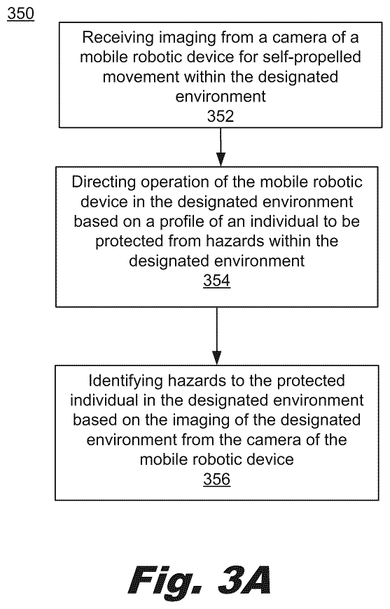

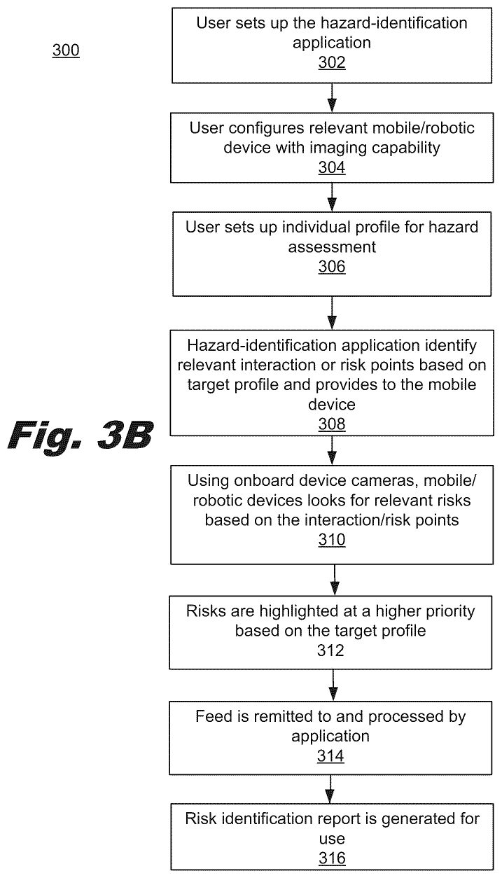

FIGS. 3A and 3B are flow charts illustrating example methods for hazard identification according to principles described herein. In the example of FIG. 3A, the method 350 includes receiving 352 imaging from a camera of a mobile robotic device for self-propelled movement within the designated environment; directing 354 operation of the mobile robotic device in the designated environment based on a profile of an individual to be protected from hazards within the designated environment; and identifying 356 hazards to the protected individual in the designated environment based on the imaging of the designated environment from the camera of the mobile robotic device.

FIG. 3B is a more detailed illustration of a method 300 for hazard identification. As shown in FIG. 3B, the user sets up 302 the hazard identification application 204. This set up will include the following. First, the user will need to install the application on a computer device 202, such as a smartphone or tablet. To do this, the user will need to download the application from an app store or online marketplace and follow the prompts to install it on their device.

Next, the user will launch the application. The user can then configure 304 the application to interface with an available mobile robotic device to be used to search the environment. This will include identifying the mobile robotic device to be used by the application and granting access to the mobile robotic device. This includes allowing the application to access the device's camera and location data. The application will use access to the device's camera and location data to accurately map the home or other environment and identify potential risks. This may involve prompting the user to allow access to these data sources in the device's settings.

The user may then configure 304 the mobile robotic device or devices that will be used for the risk assessment, such as a drone or robotic vacuum cleaner. This may involve connecting the device to the application via Bluetooth or Wi-Fi and following any specific setup instructions. Configuring the mobile robotic devices to work with the application can also involve setting up any necessary sensors or cameras and ensuring that the device is properly powered and connected to the application. The user will need to configure the mobile robotic devices to work with the application in order to ensure that they are able to accurately identify risks in the home or other environment.

Depending on how the application is structured, the user may follow prompts to create an account. To use the application, the user can input 306 a profile of the individual or individual type that they are trying to protect. In the example of child-proofing a space, the user may create a profile for their child including age, height, and any specific needs or behaviors that may impact a risk assessment. For example, a child with autism may be more prone to wandering, so the user may want to include this information in their profile. Once the configuration is complete, the application and mobile robotic devices are ready to be used for the risk assessment. Once the configuration is complete, the user can proceed to the next stage of the process, which involves implementing the mobile robotic devices in the home and using the application to identify potential hazards.

After this set-up, the hazard identification application can identify relevant interaction or risk points based on the profile of the target individual to be protected. This information is transmitted 308 to the mobile robotic device to guide the imaging of the environment. As noted above, this may include setting a particular height or eye-level that should be searched for hazards. Then, using onboard device cameras, the mobile robotic device will look 310 for relevant risks based on the identified interaction or risk points.

The feed, e.g., images or video, is remitted 314 by the mobile robotic device to the application for processing. The application can then output 316 a risk identification that has been generated for the user. As noted above, this may include suggestions for remediating identified hazards.

Further details and alternatives for the different stages of the method in FIG. 3 will now be described. The set-up of the application and configuration to operate with the mobile robotic device or devices may be considered a first stage of the method. The second stage is the implementation within a particular building or environment. The user will need to deploy the mobile robotic devices in the desired environment, e.g., a home living space, in order to begin the risk assessment process. The application can provide guidance on where to deploy the devices in order to effectively map the environment and identify potential risks. For example, the application may recommend deploying a drone in the living room to scan for potential hazards.

For risk identification, the system will then use the mobile robotic devices to navigate through the home environment, collecting data on potential risks. In some examples, the system will use artificial intelligence and sensors to identify potential risks in the environment based on the profile of the individual to be protected. As an example, a drone may use its camera to scan for shiny objects or outlets that may be attractive to a toddler. As the mobile robotic devices navigate through the environment, they will collect data on potential risks that will be used by the application to identify hazards.

Next comes data analysis. The application will analyze the data collected by the mobile robotic devices and identify potential risks in the home environment. In some examples, the application will use machine learning algorithms to analyze the data collected by the mobile robotic devices and identify potential risks in the home environment. For example, the application may include or have access to a machine learning model that has been trained on a large set of images the identify hazards in an environment. Using this machine learning model with the images from the current environment, the application can better and more accurately identify hazards in the scanned environment. The user will be able to view these risks on the application's dashboard, along with recommendations for how to address them. For example, the application may identify an outlet that is within reach of a toddler and recommend installing a cover. Where possible, the recommendation may be for moving the hazard to a higher location.

As needed, the user can provide guidance or input to the mobile robotic devices during their normal interaction period, such as while vacuuming. The user may want to provide guidance or input to the mobile robotic devices during their normal interaction period in order to gather more information about potential risks in the home. As an example, the user may want to direct a drone to scan a specific area of the home that they are concerned about. The user can do this by using the application to provide guidance to the mobile robotic devices during their normal interaction period. This can help the user to get a more comprehensive understanding of the home environment and identify any potential risks that may have been missed during the initial assessment.

The application may also have functionality for educating the user. For example, the user is provided with training on how to use the application and mobile robotic devices. This may involve a tutorial or instructional video that explains the features and functions of the application and how to use the mobile robotic devices. As an example of this, the user may be shown how to input their child's profile and navigate the application's dashboard to view the results of the risk assessment. The user can practice using the application and mobile robotic devices to identify potential risks in their home. The user may be provided with sample scenarios or exercises to practice using the application and mobile robotic devices to identify potential risks in the home environment. For example, the user may be asked to use the application to assess a mock home environment and identify any potential hazards. This can help the user to become familiar with how the application and mobile robotic devices work and how to interpret the results of the risk assessment.

The user can also be provided with feedback on their performance and additional training as needed. The user may receive feedback on their performance during the training exercises and be provided with additional training or guidance as needed. This can help the user to become proficient in using the application and mobile robotic devices to identify potential risks in the home environment. For example, the user may receive feedback on how accurately they identified potential hazards in the mock home environment and be provided with additional training or guidance to improve their performance. Once the user has completed the training, they are ready to utilize the application and mobile robotic devices to identify potential risks in their home or other environment and take steps to address them.

When ready, the user deploys the mobile robotic devices in their home or other environment and utilizes the application to identify potential risks. The user will follow the guidance provided by the application to deploy the mobile robotic devices. For example, the user may deploy a drone in the living room, kitchen or other room to scan for potential hazards and use the application to view the results of the risk assessment. Multiple mobile robotic devices may be used to assess hazards in a single environment. For example, the user may also deploy a robotic vacuum cleaner to scan for hazards in areas of the home that are difficult for the drone to access, such as under furniture or in tight corners.

Based on the results of the risk assessment, the user can take steps to address identified hazards in their home. This may involve installing covers or guards on outlets, moving hazardous objects to a higher location, or taking other precautions to ensure the safety of their child or other individual. For example, if the application identifies an outlet that is within reach of a toddler, the user may install a cover to prevent the child from accessing it. If the outlet is on an extension cord, the user may move it higher and out of reach of the toddler.

The user may continue to utilize the application and mobile robotic devices over time to regularly assess the environment and identify potential risks. This can help the user to stay up to date on any potential hazards in the environment and take steps to address them. As an example of this, the user may set up the application to alert them when new hazards are identified or schedule regular risk assessments to ensure that the environment remains safe for their child or other individual.

If necessary, the user can provide guidance or input to the mobile robotic devices in order to gather more information about potential risks in the environment or to assess specific areas of the environment that may not have been covered during the initial assessment. For example, the user may want to direct a drone to scan a specific area of the environment that they are concerned about or have the vacuum assess an area of the environment that is difficult for the drone to access. This can help the user to get a more comprehensive understanding of the environment and identify any potential risks that may have been missed during the initial assessment.

In summary, the data inputs for processing in the system described can include: User profile (e.g. age, height, interests, disabilities); Home environment data collected by mobile robotic devices (e.g. images, sensor data); User guidance or input during mobile robotic device interaction period; and Training data for machine learning models. Implementation outputs yielded can include: Identified potential risks in the home environment; Recommendations for addressing identified risks; Updated user profile based on identified risks; and Training data for machine learning models.

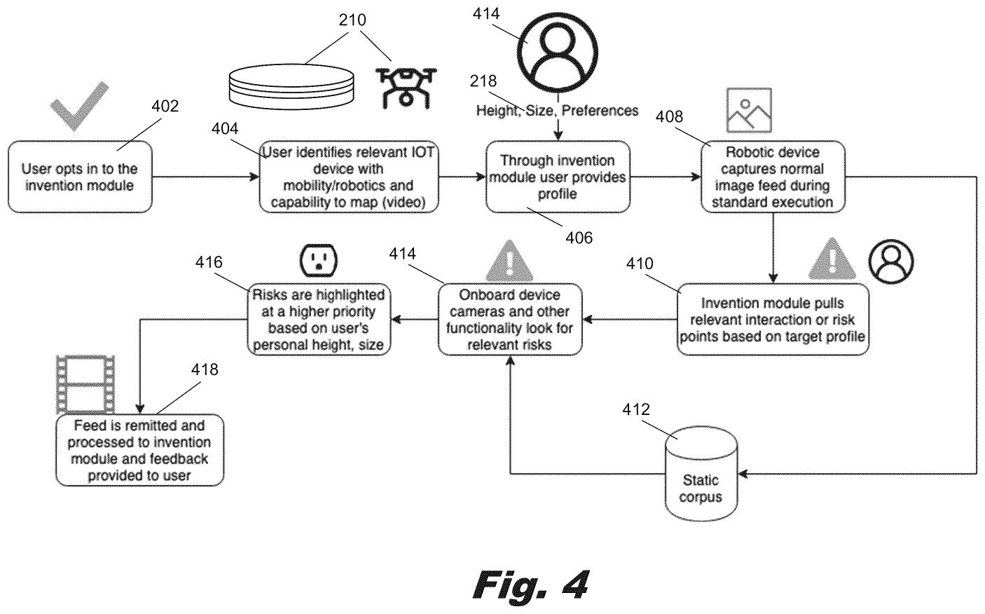

FIG. 4 is another illustration of an example hazard identification system and method according to the present description. As shown in FIG. 4, we begin with the user opting into 402 the hazard identification application or module. Next, the user identifies 404 the relevant mobile robotic devices or Internet of Things (IoT) devices with the capability to map, by video or image, the target environment. As noted above, these devices 210 may include a drone and/or a self-propelled robotic vacuum cleaner.

Next, the user provides 406 a profile 218 of the target individual 414 to be protected. This may be a child, employee, disabled individual, elderly individual, pet or any other individual or individual type. Then, the robotic device is used to capture 408 a normal image feed during standard execution. This feed may be stored in a database 412 or static corpus. The hazard identification application or module then pulls 410 relevant interaction or risk points based on the input profile. These are formed as instructions that are output to the mobile robotic device. The device then uses its onboard camera or other sensors/functionality to look 414 for relevant risks based on the specific interaction or risk points identified from the profile 218.

Risks are highlighted 416 and prioritized based on the profile of the person to be protected, i.e., height, eye-level, etc. The image/video feed is remitted 418 to, and processed by, the hazard identification application and feedback is provided to the user as described herein.

Additional features of the system may include the following. The hazard identification application will take user input of a profile for an individual and identify relevant camera-based mobile robotic devices to map a location in context of that individual. The mobile robotic device may take guidance or input during its normal interaction period unrelated to the user's prime directive. For example, a mobile robotic vacuum cleaner will scan for risks during vacuuming. The camera of the mobile robotic device takes mapping images and doesn't need live execution mapping of the profile. Static images taken during vacuuming can be used for risk identification. The mobile robotic device may mock up or follow behavior of a given individual based on watching their behavior or real-world pathing. A robotic vacuum follows the path of a pet, such as a cat, and its normal behavior to find frequent areas of movement. The hazard identification application may recommend remedial measures for identified hazards, but simply highlight risks that aren't expected to be “visible” to the protected individual based on the individual's profile, e.g., height. Outlets are highlighted based on the user's height. The hazard identification application is able to interface with other IOT or home smart devices in gathering risk detection criteria. For example, the hazard identification application can interface with a smart range/stove to check active status and accessibility to toddler or other protected individual.

Several specific use cases will now be described.
Use Case 1: Jake is a first-time parent of a 6-month-old baby. He is concerned about ensuring the safety of his child in their home, but he is struggling to identify potential hazards from the child's perspective. Jake decides to use the proposed application to assist with childproofing their home. He inputs his child's profile, including age, height, and any specific needs or behaviors, and the application utilizes mobile technology and robotics (Jake's iRobot vacuum) to map the home environment in context of the child's profile. The application highlights potential risks, such as outlets and sharp corners, and provides recommendations for how to address these hazards. Jake is able to use the application's assessment to childproof their home with confidence, ensuring the safety of his child.
Use Case 2: Jessica is a young mother with a newborn baby, and she is constantly worried about the safety of her home. When she heard about the new childproofing application, she was eager to try it out. Jessica downloaded the application and input her baby's profile, including the child's age, height, and interests. She then deployed the mobile robotic devices (child's remote- control car with camera) in her home and used the application to identify potential risks in the home environment. The application provided recommendations for how to address these risks, including installing covers on outlets and moving hazardous objects to a higher location. Jessica was able to quickly and easily identify potential risks in her home and take steps to address them, giving her peace of mind and ensuring the safety of her newborn baby as it will be crawling and walking soon enough.
Use Case 3—Small Business: A daycare center is looking for a solution to childproof their facility to ensure the safety of the children in their care. They decide to use the proposed application to identify potential risks and hazards in their space that they are renovating within an old building. The application utilizes mobile technology and robotics (Security Robot) to map the facility in context of the children's profiles, highlighting areas of concern such as outlets or sharp corners. The daycare center is able to use the application's assessment to childproof their facility and provide a safe environment for the children.

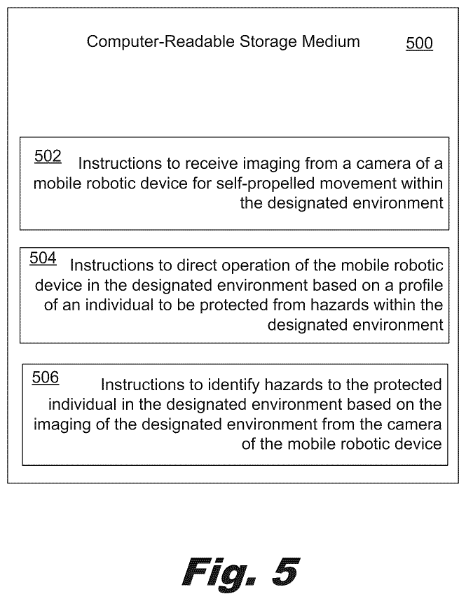

FIG. 5 depicts a computer-readable storage medium as an example for implementing the hazard identification application described herein. As shown in FIG. 5, a computer program product comprising a non-transitory computer-readable medium 500 storing instructions that, when executed by a processor, implement a hazard identification application, as described herein. Specifically, within the context of the application, the medium 500 stores: instruction to receive imaging from a camera of a mobile robotic device for self-propelled movement within the designated environment; instruction to direct operation of the mobile robotic device in the designated environment based on a profile of an individual to be protected from hazards within the designated environment; and instruction to identify hazards to the protected individual in the designated environment based on the imaging of the designated environment from the camera of the mobile robotic device.

In conclusion, aspects of the system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. In one example, the computer usable program code may be embodied within a computer readable storage medium; the computer readable storage medium being part of the computer program product. In one example, the computer readable storage medium is a non-transitory computer readable medium.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A hazard identification system comprising:
a computer device comprising a hazard identification application; and
a mobile robotic device for self-propelled movement within a designated environment and with an interface for communicating with the hazard identification application, the mobile robotic device further comprising a camera for imaging the designated environment;
the hazard identification application to receive imaging of the designated environment from the camera of the mobile robotic device and to identify hazards in the designated environment from the imaging.

2. The system of claim 1, wherein the hazard identification application is to output a report of the identified hazards along with directions for mitigating the identified hazards.

3. The system of claim 1, further comprising a user interface of the hazard identification application to receive a profile of an individual or type of individual to be protected from hazards in the designated environment, the application to send instructions to the robotic device based on the profile.

4. The system of claim 3, wherein the profile comprises an actual path of the individual while moving in the designated environment as a guide for searching for hazards with the mobile robotic device.

5. The system of claim 3, wherein the individual profiled is a pet.

6. The system of claim 1, wherein the mobile robotic device comprises a flying drone.

7. The system of claim 1, wherein the mobile robotic device comprises a robotic vacuum cleaner.

8. The system of claim 5, wherein the robotic vacuum cleaner searches for hazards in the designated environment while vacuuming.

9. The system of claim 1, further comprising a trained machine learning model that is trained to identify hazards from the imaging received from the mobile robotic device.

10. The system of claim 1, further comprising a user interface of the hazard identification application to receive a profile of an individual or type of individual to be protected from hazards in the designated environment, the application to send instructions to the robotic device based on the profile;
wherein the hazard identification application is to output a report of the identified hazards along with directions for mitigating the identified hazards; and
wherein the report distinguishes between hazards that are relevant to the protected individual based on the profile and risks that are not hazards for the protected individual based on the profile.

11. The system of claim 1, further comprising an interface of the hazard identification application to communicate with smart devices in the designated environment as to operating status, the application further identifying hazards in the designated environment based on the operating status of the smart devices.

12. A method of hazard identification in a designated environment, the method comprising:
receiving imaging from a camera of a mobile robotic device for self-propelled movement within the designated environment;
directing operation of the mobile robotic device in the designated environment based on a profile of an individual to be protected from hazards within the designated environment; and
identifying hazards to the protected individual in the designated environment based on the imaging of the designated environment from the camera of the mobile robotic device.

13. The method of claim 12, further comprising outputting a report of the identified hazards along with directions for mitigating the identified hazards.

14. The method of claim 12, wherein the profile comprises an actual path of the individual while moving in the designated environment as a guide for searching for hazards with the mobile robotic device.

15. The method of claim 12, wherein the mobile robotic device comprises a flying drone or a robotic vacuum cleaner.

16. The method of claim 12, further comprising using a trained machine learning model that is trained to identify hazards from the imaging received from the mobile robotic device.

17. The method of claim 12, further comprising distinguishing between hazards that are relevant to the protected individual based on the profile and risks that are not hazards for the protected individual based on the profile.

18. The method of claim 12, further comprising:
communicating with smart devices in the designated environment as to operating status; and
identifying hazards in the designated environment based on the operating status of the smart devices.

19. A computer program product comprising a non-transitory computer-readable storage medium storing instructions that, when executed by a processor, implement a hazard identification application, the application to:
receive imaging from a camera of a mobile robotic device for self-propelled movement within the designated environment;
direct operation of the mobile robotic device in the designated environment based on a profile of an individual to be protected from hazards within the designated environment; and
identify hazards to the protected individual in the designated environment based on the imaging of the designated environment from the camera of the mobile robotic device.

20. The computer program product of claim 19 wherein the application is further to display a report of the identified hazards along with directions for mitigating the identified hazards.
